(19) United States
(12) Patent Application Publication
(10) Pub. No.: US 2023/0056735 A1
(43) Pub. Date: Feb. 23, 2023

(54) METHOD OF PERFORMING CLASSIFICATION PROCESSING USING MACHINE LEARNING MODEL, INFORMATION PROCESSING DEVICE, AND COMPUTER PROGRAM

(71) Applicant: SEIKO EPSON CORPORATION, TOKYO (JP)

(72) Inventors: Ryoki WATANABE, Matsumoto-shi (JP); Hikaru KURASAWA, Matsumoto-shi (JP); Shin NISHIMURA, Shiojiri-shi (JP)

(21) Appl. No.: 17/820,711

(22) Filed: Aug. 18, 2022

(30) Foreign Application Priority Data
Aug. 18, 2021 (JP) 2021-133183

(51) Int. Cl. G06N 3/08

(52) U.S. Cl. CPC G06N 3/08

(57) ABSTRACT

A method of performing classification processing on classification target data includes: (a) a step of preparing N machine learning models; (b) a step of, when a plurality of pieces of training data are input into the N machine learning models, preparing a known feature vector group obtained from output of at least one specific layer of the plurality of vector neuron layers; and (c) a step of computing, using a selected machine learning model selected from the N machine learning models a similarity, for each class, between the known feature vector group and a feature vector obtained from output of the specific layer when the classification target data is input into the selected machine learning model, and determining a class for the classification target data using the similarity.

The present application is based on, and claims priority from JP Application Serial Number 2021-133183, filed on Aug. 18, 2021, the disclosure of which is hereby incorporated by reference herein in its entirety.

### BACKGROUND

### 1. Technical Field

The present disclosure relates to a method of performing classification processing using a machine learning model, an information processing device, and a computer program.

### 2. Related Art

JP-A-2019-204321 discloses a technique of performing classification of input data using a variational autoencoder (VAE). In this technique, the VAE is created for each class for which determination is made, and input data is compared with data outputted from one VAE, whereby determination is made as to whether or not the input data belongs to the class corresponding to this VAE. When the input data does not belong to the class corresponding to this VAE, determination is made again by using another VAE.

However, with this technique, a VAE needs to be created for each class. This leads to an increase in the amount of process, which results in a problem in that it takes much time to perform computation.

### SUMMARY

A first aspect according to the present disclosure provides a method of performing classification processing on classification target data using a machine learning model including a vector neural network including a plurality of vector neuron layers. This method includes (a) preparing N machine learning models, each of the N machine learning models being configured to classify input data into any one of a plurality of classes, each of the N machine learning models being also configured to include at least one class differing from other machine learning models of the N machine learning models, where N is an integer equal to or more than 2, (b) when a plurality of pieces of training data are input into the N machine learning models, preparing a known feature vector group obtained from output of at least one specific layer of the plurality of vector neuron layers, and (c) computing, using a selected machine learning model selected from the N machine learning models a similarity, for each class, between the known feature vector group and a feature vector obtained from output of the specific layer when the classification target data is input into the selected machine learning model, and determining a class for the classification target data using the similarity.

A second aspect according to the present disclosure provides an information processing device configured to perform classification processing on classification target data using a machine learning model including a vector neural network including a plurality of vector neuron layers. This information processing device includes a memory configured to store the machine learning model, and one or more processors configured to execute computation using the machine learning model. The one or more processors perform (a) processing of preparing N machine learning models, each of the N machine learning models being configured to classify input data into any one of a plurality of classes, each of the N machine learning models being also configured to include at least one class differing from other machine learning models of the N machine learning models, where N is an integer equal to or more than 2, (b) processing of, when a plurality of pieces of training data are input into the N machine learning models, preparing a known feature vector group obtained from output of at least one specific layer of the plurality of vector neuron layers, and (c) processing of computing, using a selected machine learning model selected from the N machine learning models a similarity, for each class, between the known feature vector group and a feature vector obtained from output of the specific layer when the classification target data is input into the selected machine learning model, and determining a class for the classification target data using the similarity.

A third aspect according to the present disclosure provides a non-transitory computer-readable storage medium storing a computer program, the computer program being configured to cause one or more processors to perform classification processing on classification target data using a machine learning model including a vector neural network including a plurality of vector neuron layers. The computer program is configured to cause the one or more processors to perform (a) processing of preparing N machine learning models, each of the N machine learning models being configured to classify input data into any one of a plurality of classes, each of the N machine learning models being also configured to include at least one class differing from other machine learning models of the N machine learning models, where N is an integer equal to or more than 2, (b) processing of, when a plurality of pieces of training data are input into the N machine learning models, preparing a known feature vector group obtained from output of at least one specific layer of the plurality of vector neuron layers, and (c) processing of computing, using a selected machine learning model selected from the N machine learning models, a similarity, for each class, between the known feature vector group and a feature vector obtained from output of the specific layer when the classification target data is input into the selected machine learning model, and determining a class for the classification target data using the similarity.

### BRIEF DESCRIPTION OF THE DRAWINGS

FIG. 1 is a block diagram illustrating an information processing device according to an embodiment.

FIG. 2 is a block diagram illustrating a control device.

FIG. 3 is an explanatory view illustrating a configuration of a first machine learning model.

FIG. 4 is an explanatory view illustrating a configuration of a second machine learning model.

FIG. 5 is a flowchart showing a process procedure of a preparation step.

FIG. 6 is an explanatory view illustrating a feature spectrum.

FIG. 7 is an explanatory view illustrating a configuration of a known feature spectrum group.

FIG. 8 is a flowchart showing a process procedure of a classification step.

FIG. 9 is a flowchart showing a process procedure of a step of updating a machine learning model.

FIG. 10 is a flowchart showing a process procedure of a class deleting step.

### DESCRIPTION OF EXEMPLARY EMBODIMENTS

### A. Embodiment

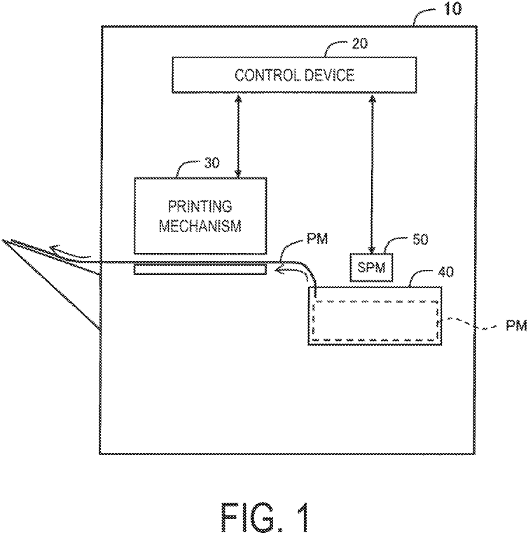

FIG. 1 is a block diagram illustrating functions of a printer 10 serving as an information processing device according to an embodiment. The printer 10 includes a control device 20, a printing mechanism 30, a printing medium holder 40, and a spectrum analyzer 50. A printing medium PM is accommodated in the printing medium holder 40. The spectrum analyzer 50 performs spectrum analysis to the printing medium PM accommodated in the printing medium holder 40 to acquire spectral data. The spectrum analyzer 50 includes, for example, a wavelength-changeable interference spectrum filter, and a monochrome image sensor. The spectral data obtained by the spectrum analyzer 50 is used as input data or classification target data that is put into a machine learning model that will be described later. As described later, the control device 20 performs classification processing on the spectral data using a machine learning model to perform classification as to which class of the plurality of classes the printing medium PM belongs to. The “class of the printing medium PM” means a type of the printing medium PM. The control device 20 controls the printing mechanism 30 such that printing is performed under an appropriate printing condition that fits the type of the printing medium PM. Note that the present disclosure can be applied to various types of information processing device, in addition to the printer 10.

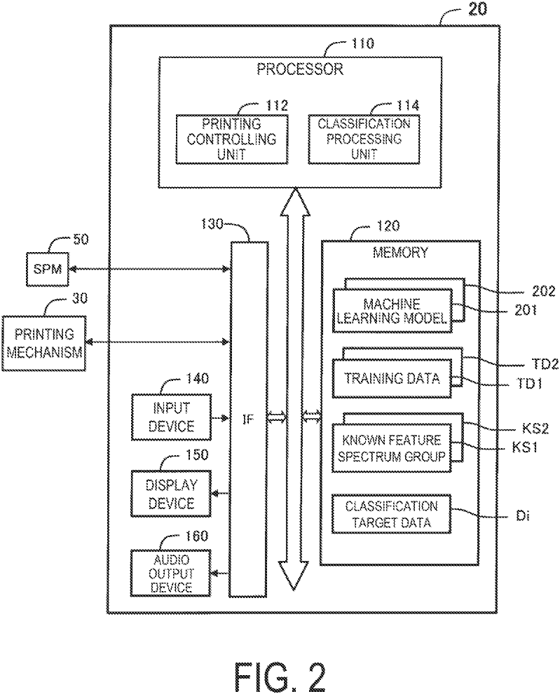

FIG. 2 is a block diagram illustrating functions of the control device 20. The control device 20 includes a processor 110, a memory 120, an interface circuit 130, an input device 140 coupled to the interface circuit 130, a display device 150, and an audio output device 160. Although limitation is not applied, for example, the processor 110 not only has a function of performing processes that will be described in detail below but also has a function of displaying or audibly outputting data obtained through the processes described above and data generated through the processes described above, to the display device 150 and/or the audio output device 160. The spectrum analyzer 50 and the printing mechanism 30 are also coupled to the interface circuit 130.

The processor 110 may be comprised of one or more processors. The processor 110 functions as a printing controlling unit 112 configured to control the printing mechanism 30, and also functions as classification processinging unit 114 configured to perform classification processing on input data. Each of these units 112 and 114 are achieved such that the processor 110 executes a computer program stored in the memory 120. However, each of these units 112 and 114 may be achieved with a hardware circuit. The “processor” as used herein represents a term including such a hardware circuit. In addition, the one or more processors that perform the classification processing may be processors included in one or more remote computers coupled to the printer 10 through a network. The memory 120 stores a plurality of machine learning models 201 and 202, a plurality of training data groups TD1 and TD2, a plurality of known feature spectrum groups KS1 and KS2, and classification target data Di. The machine learning models 201 are 202 are used for computation by the classification processing unit 114. Examples of the configuration of or operations of the machine learning model 201, 202 will be described later. The training data group TD1, TD2 is a group of labeled spectral data used to train the machine learning model 201, 202. The known feature spectrum group KS1, KS2 is a group of feature spectra obtained when the training data group TD1, TD2 is input again into the trained machine learning model 201, 202. The feature spectrum will be described later. The classification target data Di is spectral data on a new printing medium PM serving as the process target of the classification process.

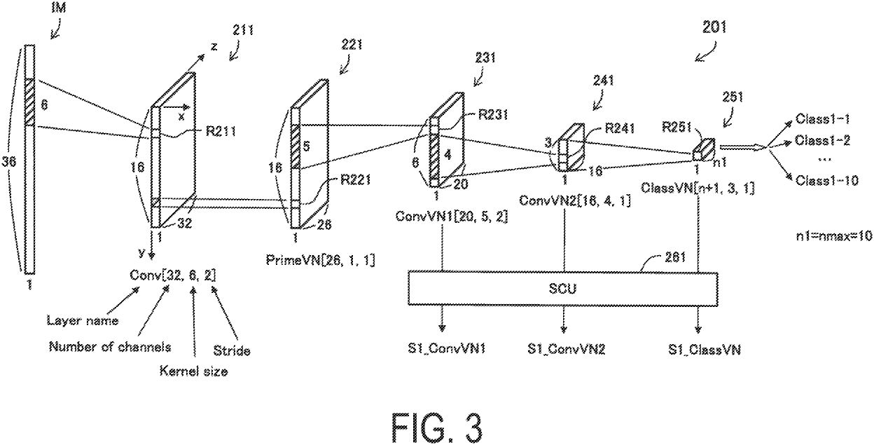

FIG. 3 is an explanatory view illustrating the configuration of the first machine learning model 201. This machine learning model 201 includes a convolutional layer 211, a primary vector neuron layer 221, a first convolutional vector neuron layer 231, a second convolutional vector neuron layer 241, and a classification vector neuron layer 251 provided sequentially in an order from the side of the input data IM. Of these five layers 211 to 251, the convolutional layer 211 is the lowermost layer, and the classification vector neuron layer 251 is the uppermost layer. In the following description, the layers 211 to 251 are also referred to as a “Conv layer 211”, a “PrimeVN layer 221”, a “ConvVN1 layer 231”, a “ConvVN2 layer 241”, and a “ClassVN layer 251”, respectively.

In the present embodiment, the input data IM is spectral data, and hence, is one-dimensional array data. For example, the input data IM are data obtained by extracting 36 pieces of representative values from spectral data ranging from 380 nm to 730 nm for every 10 nm. However, as for the input data IM, it may be possible to use two-dimensional array data such as an image.

Although two convolutional vector neuron layers 231 and 241 are used in the example in FIG. 3, the number of convolutional vector neuron layers may be any given number, and the convolutional vector neuron layer may not be provided. However, it is preferable to use one or more convolutional vector neuron layers.

The machine learning model 201 in FIG. 3 further includes a similarity calculating unit 261 configured to generate a similarity. The similarity calculating unit 261 is able to calculate similarities S1_ConvVN1, S1_ConvVN2, and S1_ClassVN, which will be described later, on the basis of output from the ConvVN1 layer 231, the ConvVN2 layer 241, and the ClassVN layer 251, respectively. However, the similarity calculating unit 261 may not be provided.

The configuration of each of the layers 211 to 251 can be expressed in the following manner.

Expression of the configuration of the first machine learning model 201
Conv layer 211: Conv[32, 6, 2]
PrimeVN layer 221: PrimeVN[26, 1, 1]
ConvVN1 layer 231: ConvVN1[20, 5, 2]
ConvVN2 layer 241: ConvVN2[16, 4, 1]
ClassVN layer 251: ClassVN[n1, 3, 1]
Vector dimension VD: VD = 16

In the description of each of the layers 211 to 251, the character string preceding the brackets indicates a layer name, and the numbers within the brackets indicate the number of channels, the kernel size, and the stride in order. For example, the layer name of the Conv layer 211 is “Conv”, the number of channels is 32, the kernel size is 1 × 6, and the stride is 2. In FIG. 3, these characters are indicated below each of the layers. The hatched rectangles illustrated within each of the layers each represent a kernel used at the time of calculating the output vector of an adjacent upper layer. In the present embodiment, since the input data IM is one-dimensional array data, the kernel also has a one-dimensional array. Note that the values of the parameters used in the description of each of the layers 211 to 251 are given as an example. Thus, it is possible to change them as appropriate.

The Conv layer 211 is a layer configured with a scalar neuron. The other four layers 221 to 251 are layers each configured with a vector neuron. The vector neuron is a neuron where a vector is input or outputted. In the description above, the dimension of the output vector of each vector neuron is 16 and is constant. Hereinafter, a term “node” is used as a superordinate of the scalar neuron and the vector neuron.

As for the Conv layer 211, FIG. 3 illustrates a first axis x and a second axis y that define the plane coordinate of the node array, and also illustrates a third axis z that indicates the depth. In addition, the sizes of the Conv layer 211 in the x, y, and z directions are illustrated to be 1, 16, and 32. The size in the x direction and the size in the y direction are also each referred to as “resolution”. In the present embodiment, the resolution in the x direction is always 1. The size in the z direction represents the number of channels. These three axes x, y, and z are also used for the other layers as the coordinate axes indicating the position of each node. However, in FIG. 3, these axes x, y, and z are not illustrated for layers other than the Conv layer 211.

As is well known, the resolution W1 in the y direction after convolution can be given as the following expression. W1 = Ceil{(W0 - Wk + 1)/S} (1)

Here, the W0 represents the resolution before convolution. The Wk represents the kernel size. The S represents the stride. The Ceil{X} represents a function of performing computation in which numbers after the decimal point of X is rounded up.

The resolution of each of the layers illustrated in FIG. 3 gives an example in which the resolution of the input data IM in the y direction is 36. The actual resolution of each of the layers is changed on an as-necessary basis in accordance with the size of the input data IM.

The ClassVN layer 251 has n1 pieces of channels. The example in FIG. 3 shows n1 = 10. Determination values Class1-1 to Class1-10 corresponding to a plurality of known classes are outputted from these channels. The class having the maximum value of all these determination values Class1-1to Class1-10 corresponds to a class that the input data IM belongs to. In general, the “n1” is an integer equal to or more than 1, and is the number of known classes into which classification can be performed using the first machine learning model 201. In any one machine learning model, it is preferable that the upper limit value nmax is set in advance for the number n1 of known classes into which classification can be performed. In the example in FIG. 3, the number n1 of known classes is equal to 10 that is the upper limit value nmax. The upper limit value nmax may be a theoretical upper limit value that can satisfy a predetermined classification accuracy, or may be a practical upper limit value having a number smaller than the theoretical upper limit value. Basically, the practical upper limit value provides classification accuracy higher than the theoretical upper limit value. In addition, the upper limit value nmax can be set independently in the plurality of machine learning models 201, 202, and can be set to values differing from each other.

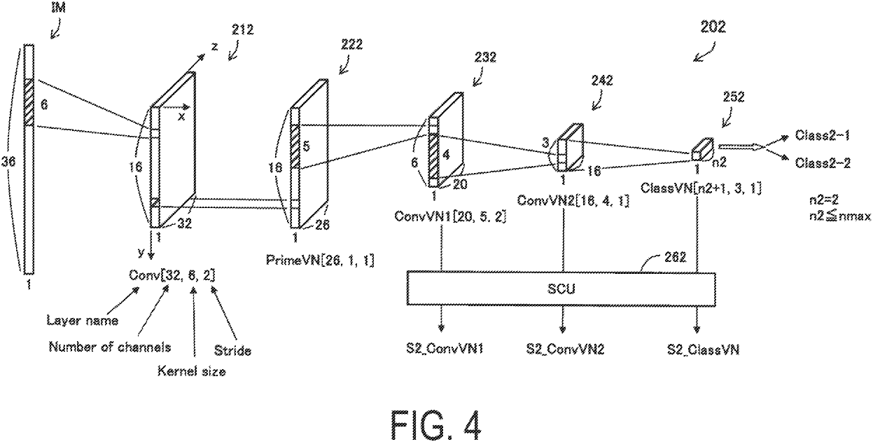

FIG. 4 is an explanatory view illustrating the configuration of the second machine learning model 202. As with the first machine learning model 201, the machine learning model 202 includes a Conv layer 212, a PrimeVN layer 222, a ConvVN1 layer 232, a ConvVN2 layer 242, a ClassVN layer 252, and a similarity calculating unit 262.

The configuration of each of the layers 212 to 252 can be expressed in the following manner.

Expression of the configuration of the second machine learning model 202.
Conv layer 212: Conv[32, 6, 2]
PrimeVN layer 222: PrimeVN[26, 1, 1]
ConvVN1 layer 232: ConvVN1[20, 5, 2]
ConvVN2 layer 242: ConvVN2[16, 4, 1]
ClassVN layer 252: ClassVN[n2, 3, 1]
Vector dimension VD: VD = 16

As can be understood from the comparison between FIGS. 3 and 4, of the layers 212 to 252 of the second machine learning model 202, the lower four layers 212 to 242 have the same configuration as those of the layers 211 to 241 of the first machine learning model 201. On the other hand, the uppermost layer 252 of the second machine learning model 202 differs from the uppermost layer 251 of the first machine learning model 201 only in the number of channels. In the example in FIG. 4, the ClassVN layer 252 has n2 pieces of channels with n2 = 2. Determination values Class2-1 to Class2-2 concerning a plurality of known classes are outputted from these channels. In the second machine learning model 202, it is preferable that the same upper limit value nmax as that in the first machine learning model 201 is set for the number n2 of known classes. In the example in FIG. 4, the number n2 of known classes is smaller than the upper limit value nmax. In this case, the second machine learning model 202 is expressed as “having the number of classes less than the upper limit value nmax”. However, in the plurality of machine learning models 201, 202, it may be possible to set the upper limit value nmax of the number of classes to values differing from each other.

The second machine learning model 202 is configured so as to include at least one known class differing from any other known classes in the first machine learning model 201. In addition, classes into which classification is performed differ between the first machine learning model 201 and the second machine learning model 202, and thus, values of elements of kernels differ from each other. In the present disclosure, any one machine learning model of N machine learning models is configured so as to include at least one known class differing from any known classes of other machine learning models, where N is an integer equal to or more than 2.

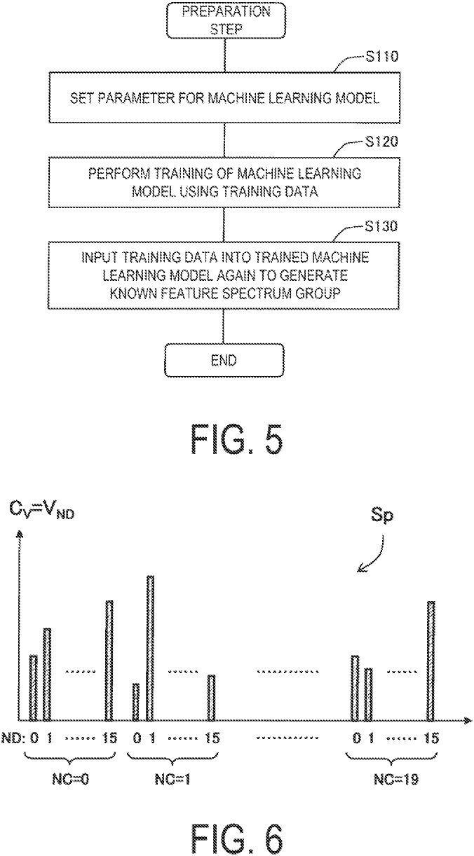

FIG. 5 is a flowchart showing a process procedure of a step of preparing a machine learning model. In step S110, a user generates a machine learning model used in classification processing, and sets parameters thereof. In the present embodiment, the two machine learning models 201 and 202 illustrated in FIGS. 3 and 4 are generated, and then, parameters thereof are set. However, in step S110, only one machine learning model may be generated, or three or more machine learning models may be generated. In step S120, the classification processing unit 114 uses the training data groups TD1 and TD2 to train the machine learning models 201 and 202. A label is attached in advance to each of the training data. For example, the first machine learning model 201 includes 10 known classes, and hence, a label with a value that falls in a range of 1 to 10 is attached to the training data thereof. After the training ends, the trained machine learning models 201 and 202 are stored in the memory 120.

In step S130, the classification processing unit 114 re-inputs the plurality of training data groups TD1 and TD2 into the trained machine learning models 201 and 202 again to generate the known feature spectrum groups KS1 and KS2. The known feature spectrum group KS1, KS2 is a group of feature spectra described below. Below, description will be mainly made of a method of generating the known feature spectrum group KS1 associated with the machine learning model 201.

FIG. 6 is an explanatory view illustrating a feature spectrum Sp obtained by inputting given input data into the trained machine learning model 201. Here, the feature spectrum Sp obtained on the basis of output from the ConvVN1 layer 231 will be described. The horizontal axis in FIG. 6 indicates positions of spectra each expressed as a combination of a channel number NC and an element number ND of an output vector of a node at one planar position (x, y) of the ConvVN1 layer 231. In the present embodiment, the vector dimension of a node is 16. Thus, the element number ND of an output vector falls in a range of 0 to 15, and the number of element numbers is 16. Furthermore, the number of channels of the ConvVN1 layer 231 is 20. Thus, the channel number NC falls in a range of 0 to 19, and the number of channel numbers is 20.

The vertical axis in FIG. 6 indicates feature values Cv at each spectrum position. In this example, the feature value Cv is a value V_{ND} of each element of an output vector. Note that, as for the feature value Cv, it may be possible to use a value obtained by multiplying the value V_{ND} of each element of an output vector and an activation value that will be described later, or use the activation value as it is. In the latter case, the number of the feature values Cv included in the feature spectrum Sp is equal to the number of channels, and is 20. Note that the activation value is a value corresponding to the vector length of the output vector of the node.

The number of the feature spectra Sp obtained from the output of the ConvVN1 layer 231 for each input data is equal to the number of the planar positions (x, y) of the ConvVN1 layer 231, and hence, is 1 × 6 = 6 pieces. Similarly, three feature spectra Sp can be obtained from the output of the ConvVN2 layer 241 for each input data, and one feature spectrum Sp can be obtained from the output of the ClassVN layer 251.

When the training data group TD1 is input into the trained machine learning model 201 again, the similarity calculating unit 261 calculates the feature spectrum Sp illustrated in FIG. 6, and registers it in the known feature spectrum group KS1.

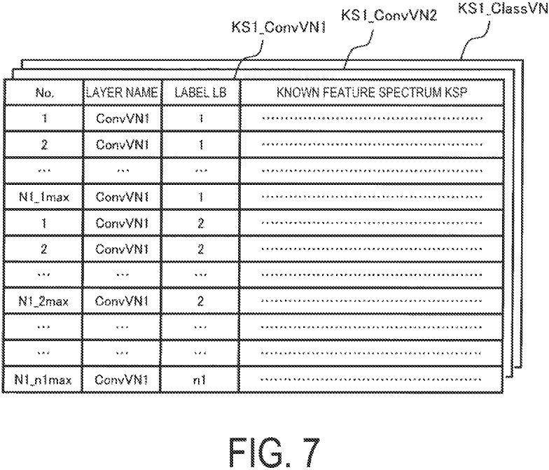

FIG. 7 is an explanatory view illustrating the configuration of the known feature spectrum group KS1. In this example, the known feature spectrum group KS1 includes a known feature spectrum group KS1_ConvVN1 obtained on the basis of the output of the ConvVN1 layer 231, the known feature spectrum group KS1_ConvVN2 obtained on the basis of the output of the ConvVN2 layer 241, and the known feature spectrum group KS1_ConvVN1 obtained on the basis of the output of the ClassVN layer 251.

Each record of the known feature spectrum group KS1_ConvVN1 includes a record number, a layer name, a label Lb, and a known feature spectrum KSp. The known feature spectrum KSp is the same as the feature spectrum Sp in FIG. 6 that is obtained in response to the input of the training data. In the example in FIG. 7, by inputting the training data group TD1 into the trained machine learning model 201, the known feature spectrum KSp associated with a value of each label Lb is generated on the basis of the output of the ConvVN1 layer 231, and is registered. For example, N1_1max pieces of known feature spectra KSp are registered so as to be associated with the label Lb = 1. N1_2max pieces of known feature spectra KSp are registered so as to be associated with the label Lb = 2. N1_n1max pieces of known feature spectra KSp are registered so as to be associated with the label Lb = n1. Each of the N1_1max, the N1_2max, and the N1_n1max is an integer equal to or more than 2. As described above, the individual labels Lb correspond to known classes differing from each other. Thus, it can be understood that individual known feature spectra KSp in the known feature spectrum group KS1_ConvVN1 are registered so as to be associated with one class from among a plurality of known classes. This similarly applies to other known feature spectrum groups KS1_ConvVN2 and KS1_ConvVN1.

Note that the training data used in step S130 are not necessarily the same as the plurality of training data groups TD1 and T2 used in step S120. However, in step S130, by using a portion of or all of the plurality of training data groups TD1 and TD2 used in step S120, it brings an advantage in which there is no need to prepare new training data.

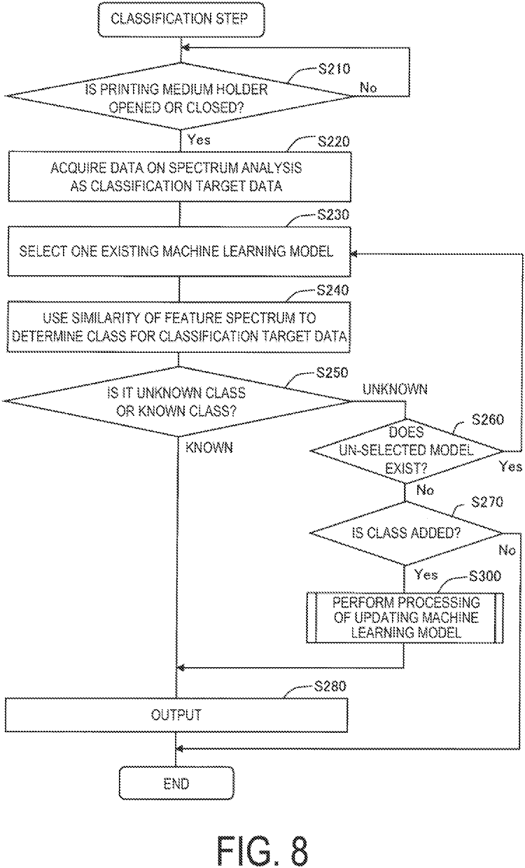

FIG. 8 is a flowchart showing a process procedure of a classification step using a trained machine learning model. In step S210, the classification processing unit 114 determines whether or not the printing medium holder 40 is opened or closed, and waits until it is opened or closed. This determination is made on the basis of the output signal from an open-close switch that is not illustrated and is disposed at the printing medium holder 40. When the printing medium holder 40 is opened or closed, the process proceeds to step S220, and the classification processing unit 114 causes the spectrum analyzer 50 to perform spectrum analysis to the printing medium PM to acquire spectral data. This spectral data serves as the classification target data Di that is the target of the classification process.

In step S230, the classification processing unit 114 selects one from among existing trained machine learning models 201 and 202. The machine learning model selected in step S230 is referred to as a “selected machine learning model”. In the following description, it is assumed that the first machine learning model 201 is selected as the selected machine learning model.

In step S240, the selected machine learning model 201 is used to calculate a similarity relative to the known feature spectrum group, and the class for the classification target data Di is determined on the basis of the similarity. Specifically, the similarity calculating unit 261 of the selected machine learning model 201 calculates, for each class, similarities S1_ConvVN1, S1_ConvVN2, and S1_ClassVN relative to the known feature spectrum group KS1, on the basis of the output from the ConvVN1 layer 231, the ConvVN2 layer 241, and the ClassVN layer 251. Below, description will be made of a method of calculating a similarity S1_ConvVN1 for each class on the basis of the output from the ConvVN1 layer 231 of the selected machine learning model 201.

The similarity S1_ConvVN1 can be calculated, for example, by using the following equation.

S1_ConvVN1(Class) = max[G{Sp(i, j), KSp(Class, k)}], where the “Class” represents an ordinal number concerning a plurality of classes; the G{a, b} is a function used to obtain a similarity between a and b; the Sp(i, j) is a feature spectrum at planar positions (i, j) obtained in response to the classification target data Di; the KSp(Class, k) represents all known feature spectra associated with the ConvVN1 layer 231 and a specific “Class”; the “k” represents an ordinal number of known feature spectrum; and the “max[X]” represents a logical operation that takes the maximum value of X. That is, the similarity S1_ConvVN1 has the maximum value of the similarities calculated between each of the feature spectra Sp (i, j) at all planar positions (i, j) of the ConvVN1 layer 231 and each of all the known feature spectra KSp(k) corresponding to a specific class. Such a similarity S1_ConvVN1 can be obtained for each of a plurality of classes corresponding to a plurality of labels Lb. The similarity S1_ConvVN1 indicates the degree at which the classification target data Di is similar to the feature of each class.

The similarities S1_ConvVN2 and S1_ClassVN concerning the output from the ConvVN2 layer 241 and the ClassVN layer 251 are also generated in a manner similar to the similarity S1_ConvVN1. Note that all these three similarities S1_ConvVN1, S1_ConvVN2, and S1_ClassVN are not necessarily generated. However, it is preferable to generate one or more of these similarities of these three similarities. In the present disclosure, a layer used to generate the similarity is also referred to as a “specific layer”.

These similarities S1_ConvVN1, S1_ConvVN2, and S1_ClassVN indicate the degree at which the classification target data Di is similar to the feature of each class. Thus, by using at least one of these similarities S1_ConvVN1, S1_ConvVN2, and S1_ClassVN, it is possible to determine a class for the classification target data Di. For example, when all three similarities S1_ConvVN1, S1_ConvVN2, and S1_ClassVN concerning a certain class is a predetermined threshold value or more, it is determined that the classification target data Di belongs to this class. On the other hand, when at least one of the three similarities S1_ConvVN1, S1_ConvVN2, and S1_ClassVN concerning a certain class is less than a threshold value, it is determined that the classification target data Di does not belong to this class. In addition, when this method results in a situation where the classification target data Di does not belong to any class associated with the known feature spectrum obtained from the machine learning model 201, the classification target data Di is determined to belong to an unknown class for this machine learning model 201. In other embodiment, when the predetermined number of similarities from among the three similarities S1_ConvVN1, S1_ConvVN2, and S1_ClassVN concerning a certain class is equal to or more than a threshold value, it may be possible to determine that the classification target data Di belongs to this class. In general, when the predetermined number of similarities from among a plurality of similarities generated on the basis of output from a plurality of specific layers is equal to or more than a predetermined threshold value, it may be possible to determine that the classification target data Di belongs to this class.

In the processing of determining a class described above, a class for the classification target data Di is determined by using only a similarity. However, instead of this, it may be possible to determine a class for the classification target data Di by using the similarity and the determination values Class1-1to Class1-10 of an output layer of the selected machine learning model 201. In the latter case, when the class determined on the basis of the similarities S1_ConvVN1, S1_ConvVN2, and S1_ClassVN matches the class determined on the basis of the determination values Class1-1to Class1-10, it is possible to determine that the classification target data Di belongs to this class. In addition, when the class determined on the basis of the similarities S1_ConvVN1, S1_ConvVN2, and S1_ClassVN does not match the class determined on the basis of the determination values Class1-1to Class1-10, it is possible to determine that the classification target data Di belongs to an unknown class. However, from the viewpoint of simplification of computation, it is preferable to determine a class only by using a similarity.

As described above, in step S240, it is determined that the classification target data Di belongs to any one of a plurality of classes of the selected machine learning model 201. That is, in the example in FIG. 3, it is determined that the classification target data Di belongs to any one of 10 pieces of known classes. At this time, when the classification target data Di does not belong to any of the 10 pieces of known classes, it is determined that the classification target data Di belongs to an unknown class. Note that the process in step S240 may be performed by the classification processing unit 114.

When the classification target data Di is determined to belong to a known class in step S240 described above, the process proceeds from step S250 to step S280. Then, the printing controlling unit 112 performs printing using a printing setting suitable for this known class, and the process in FIG. 8 ends. On the other hand, when the classification target data Di is determined to belong to an unknown class, the process proceeds from step S250 to step S260.

In step S260, the classification processing unit 114 determines whether or not there is any machine learning model that has not been selected from the plurality of machine learning models 201 and 202. When any machine learning model that has not been selected exists, the process returns to step S230, and the next machine learning model is selected. On the other hand, when no machine learning model that has not been selected exists, the process proceeds to step S270, and determination is made as to whether or not to add a class that corresponds to the classification target data Di. It may be possible to employ a configuration in which a user is asked as to whether or not addition of a class is necessary, and in response to the reply, the classification processing unit 114 performs it. When it is determined that a class that corresponds to the classification target data Di should be added, the process proceeds to step S300 to perform processing of updating a machine learning model. Details of step S300 will be described later. On the other hand, when it is determined that no class that corresponds to the classification target data Di needs to be added, the classification processing in FIG. 8 ends. In this case, there is a possibility that printing cannot be performed by using the printing setting that fits the classification target data Di. However, it may be possible to perform printing by using a printing setting for other printing media.

Note that, in steps S230 to S260 described above, the plurality of machine learning models 201 and 202 are sequentially selected one by one to determine a class for the classification target data Di. However, instead of this, it is possible to use the plurality of machine learning models 201 and 202 at the same time to determine a class for the classification target data Di. In the latter method, two machine learning models 201 and 202 are used at the same time to perform classification processes to the same classification target data Di in parallel, and the classification processing unit 114 integrates results of these processes. However, when machine learning models are selected one by one to perform classification processing, it is more likely that a class for the classification target data Di can be determined faster.

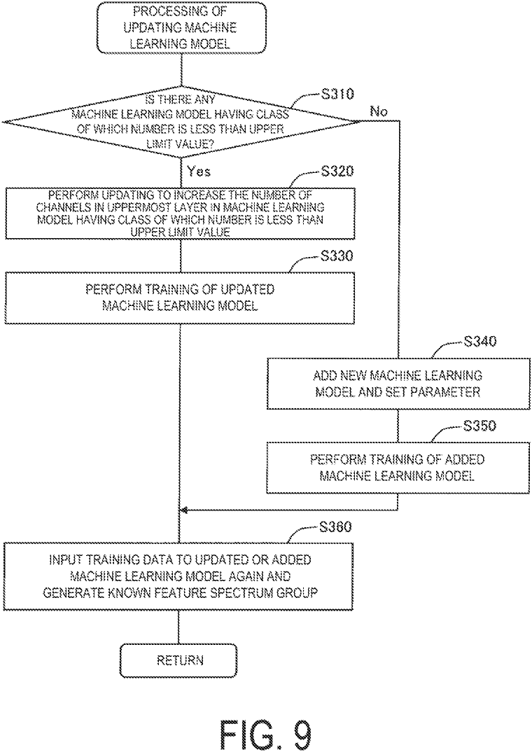

FIG. 9 is a flowchart showing a process procedure of processing of updating a machine learning model in step S300. In step S310, determination is made as to whether or not a machine learning model having the number of classes less than an upper limit value exists in existing machine learning models. When N existing machine learning models exists where N is an integer equal to or more than 2, determination is made as to whether or not, in the existing machine learning models, there is any machine learning model having the number of classes less than the upper limit value. However, the number N of the existing machine learning models may be set to 1. In the present embodiment, two existing machine learning models 201 and 202 illustrated in FIGS. 3 and 4 exist. The number of classes in the first machine learning model 201 is equal to an upper limit value, and the number of classes in the second machine learning model 202 is less than the upper limit value. When, in the existing machine learning models, there is no machine learning model having the number of classes less than the upper limit value, the process proceeds to step S340 that will be described later, and a new machine learning model is added. On the other hand, when there is any machine learning model having the number of classes less than the upper limit value, the process proceeds to step S320, and this machine learning model is updated.

In step S320, the classification processing unit 114 updates a machine learning model having the number of classes less than the upper limit value such that the number of channels of the uppermost layer of this machine learning model increases by one. In the present embodiment, the number n2 of channels of the uppermost layer of the second machine learning model 202 changes from 2 to 3. In step S330, the classification processing unit 114 performs training of the machine learning model updated in step S320. At the time of this training, the classification target data Di acquired in step S220 in FIG. 8 is used as new training data, in addition to the training data group TD2 for the second machine learning model 202 used until then. Note that, in addition to the classification target data Di acquired in step S220, it is preferable to use other plurality of pieces of spectral data obtained through spectrum analysis performed on the same printing medium PM, as the new training data. Thus, it is preferable to configure the spectrum analyzer 50 such that spectral data are acquired at a plurality of locations on one printing medium PM. After training ends as described above, the updated machine learning model 202 includes a known class that corresponds to the classification target data Di. Thus, by using the updated machine learning model 202, it is possible to identify the type of this printing medium PM.

In step S340, the classification processing unit 114 adds a new machine learning model including a class that corresponds to the classification target data Di, and sets a parameter thereof. It is preferable that this new machine learning model has the same configuration as the first machine learning model 201 illustrated in FIG. 3, except for the number of channels of the uppermost layer. It is preferable that this new machine learning model includes two or more known classes, for example, as with the second machine learning model 202 illustrated in FIG. 4. One of the two or more known classes is a class that corresponds to the classification target data Di. In addition, it is preferable that at least one of the two or more known classes is set to be the same as at least one known class of the existing machine learning model. Setting one class of a new machine learning model so as to be the same as a known class of an existing machine learning model is achieved by performing training of the new machine learning model by using the same training data as the training data used in the training of the existing machine learning model for this known class. The reason for providing two or more known classes in a new machine learning model is because, when only one known class is provided, it is more likely that this learning cannot be performed with a sufficient accuracy.

As for the class of the existing machine learning model employed as the new machine learning model, it is preferable to select it from the following classes, for example.
(a) A class corresponding to optical spectral data having the highest similarity to the classification target data Di from among a plurality of known classes in the existing machine learning model.
(b) A class corresponding to optical spectral data having the lowest similarity to the classification target data Di from among a plurality of known classes in the existing machine learning model.
(c) A class wrongly determined such that the classification target data Di belongs to in step S240 in FIG. 7 from among a plurality of known classes in the existing machine learning model.

Of these classes, when the class of (a) or (c) described above is employed, it is possible to reduce the wrong determination as to a new machine learning model. In addition, when the class of (b) is employed, it is possible to reduce the training time for a new machine learning model.

In step S350, the classification processing unit 114 performs training of the added machine learning model. In this training, the classification target data Di acquired in step S220 in FIG. 8 is used as new training data. Furthermore, in addition to the classification target data Di acquired in step S220, it is preferable to use other plurality of spectral data obtained through spectrum analysis performed on the same printing medium PM, as the new training data. In addition, when one or more classes of the new machine learning model is set so as to be the same as a known class of an existing machine learning model, the training data used in the training of the existing machine learning model for this known class is also used.

Note that, when the number of known classes of the second machine learning model 202 reaches the upper limit value, the third machine learning model is added through steps S340 and S350 in FIG. 9. This similarly applies to the fourth and subsequent machine learning models. In this manner, in the present embodiment, (N - 1) machine learning models include classes of which number is equal to the upper limit value, and the other one machine learning model includes classes of which number is equal to or less than the upper limit value, where N is an integer equal to or more than 2. In addition, when classification processing is performed on the classification target data Di by using N machine learning models and the classification target data Di is determined to belong to an unknown class, any of the following processes is performed.
(1) When the “other one machine learning model” includes classes of which number is less than the upper limit value, steps S320 and S330 are performed, and training is performed on the “other one machine learning model” by using training data including the classification target data Di to add a new class for the classification target data Di.
(2) When the “other one machine learning model” includes classes of which number is equal to the upper limit value, steps S340 and S350 are performed on add a new machine learning model including a class that corresponds to the classification target data Di.

Through these processes, even when classification cannot be successfully performed on the classification target data Di by using N machine learning models, it is possible to perform the classification as to the class that corresponds to this classification target data Di.

Note that the processing of updating the machine learning model illustrated in FIG. 9 can be performed even when the number of the existing machine learning model is one. The case where the number of the existing machine learning model is one means, for example, a case where the second machine learning model 202 illustrated in FIG. 4 is not prepared and the process in FIG. 9 is performed by using only the first machine learning model 201 illustrated in FIG. 3. In this case, steps S340 and S350 in FIG. 9 are processes of adding the second machine learning model 202 as a new machine learning model. In this manner, in the classification processing performed by using only the first machine learning model 201, there is provided the processing of adding the second machine learning model 202 as a new machine learning model when the input data thereof is determined to belong to an unknown class. This process can be understood as one example of processing of preparing two machine learning models 201 and 202.

In step S360, the classification processing unit 114 inputs training data into an updated or added machine learning model again to generate a known feature spectrum group. This process is the same process as step S130 in FIG. 5, and hence, explanation thereof will not be repeated.

As described above, in the processing of updating as illustrated in FIG. 9, when classification for the classification target data Di cannot be successfully performed by using the plurality of existing machine learning models, a class is added to the existing machine learning model or a new machine learning model is added. This makes it possible to perform classification for a class that corresponds to this classification target data Di.

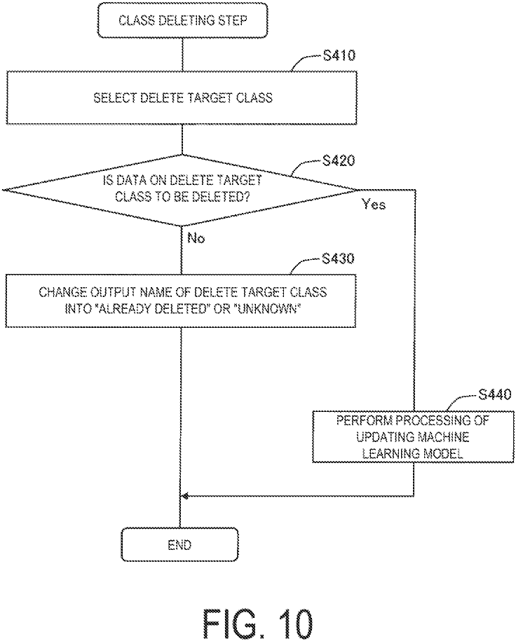

FIG. 10 is a flowchart showing a process procedure of a class deleting step. The class deleting step is started when a user wishes to delete one known class.

In step S410, a user selects a delete target class and gives an instruction to the classification processing unit 114. In step S420, in response to this instruction, the classification processing unit 114 askes the user as to whether or not data on a delete target class should be deleted.

In step S420, at the time of receiving an instruction indicating that data on the delete target class is not to be deleted, the process proceeds to step S430, and the classification processing unit 114 changes an output name of the delete target class into a name indicating “already deleted” or “unknown”. Thus, after this, when this machine learning model is used to perform the classification process, a result indicating “this medium has been deleted” or “this is an unknown medium” or the like may be outputted. On the other hand, at the time of receiving an instruction indicating that data on the delete target class is to be deleted, the process proceeds to step S440 to perform processing of updating a machine learning model that includes the delete target class as a known class. This updating process is processing of creating a new machine learning model in which one channel is deleted from the output layer of the machine learning model, and newly performing training by using training data in which data on a delete target class is deleted.

In the class deleting step described above, in response to reception of an instruction indicating that a known class is set to a delete target class, the output name of this delete target class is changed into a name indicating “already deleted” or “unknown”, or a machine learning model obtained by deleting one channel from the machine learning model including this delete target class is restructured to perform training. This makes it possible to delete this known class when this known class is not necessary, which makes it possible to increase the accuracy of the classification processing using the machine learning model.

As described above, in the present embodiment, N machine learning models are used to perform the classification process, where N is an integer equal to or more than 2. Thus, it is possible to perform the process at high speed, as compared with a case of processing of performing classification into a large number of classes using one machine learning model. In addition, a class for the classification target data is determined by using a similarity of a feature vector. This makes it possible to perform the classification processing in a highly accurate manner. Furthermore, when classification of the classification target data cannot be successfully performed by using the existing machine learning model, a class is added to the existing machine learning model or a new machine learning model is added. This makes it possible to perform classification for a class that corresponds to this classification target data.

Note that the embodiment described above employs a machine learning model of a vector neural network type using a vector neuron. However, instead of this, it may be possible to use a machine learning model using a scalar neuron as in a typical convolutional neural network. However, the machine learning model of a vector neural network type is more preferable in terms of an increase in the accuracy of the classification process, as compared with the machine learning model using a scalar neuron.

B. Method of Computing Output Vector of Each Layer of Machine Learning Model:

The method of computing output from each layer of the first machine learning model 201 illustrated in FIG. 3 is performed in the following manner. This similarly applies to the second machine learning model 202.

Each node of the PrimeVN layer 221 regards scalar output from 1 × 1 × 32 pieces of nodes of the Conv layer 211 as 32-dimensional vector, and multiplies this vector by conversion matrix to obtain vector output of this node. This conversion matrix is an element of 1 × 1 kernel, and is updated through training of the machine learning model 201. Note that it may be possible to integrate processes of the Conv layer 211 and the PrimeVN layer 221 to configure it as one primary vector neuron layer.

Where the PrimeVN layer 221 is referred to as a “lower layer L” and the ConvVN1 layer 231 disposed adjacent to this layer on the upper layer side is referred to as an “upper layer L+1”, the output of each node of the upper layer L+1 is determined by using the following Equation.

### Equation 1

### Math. 1

$${v}_{i j} = {W}_{i j}^{L} {M}_{i}^{L}$$

$${u}_{j} = {\sum }_{i} {v}_{i j}$$

$${a}_{j} = F \left(\left‖{u}_{j}\right‖\right)$$

$${M}_{j}^{L + 1} = {a}_{j} \times \frac{1}{\left‖{u}_{j}\right‖} {u}_{j}$$

Here, M^{L}ᵢ represents an output vector of i-th node in the lower layer L;
M^{L+1}ⱼ represents an output vector of j-th node in the upper layer L+1;
vᵢⱼ represents a predicted vector of the output vector M^{L+1} ⱼ;
W^{L}ᵢⱼ represents a predicted matrix used to calculate the predicted vector vᵢⱼ on the basis of the output vector M^{L}ᵢ from the lower layer L;
uⱼ represents a sum of the predicted vector vᵢⱼ, that is, a sum vector that is a linear combination;
aⱼ represents an activation value that is a normalizing constant obtained by normalizing a norm |uⱼ| of the sum vector uⱼ; and
F(X) represents a normalizing function for normalizing X.

As for the normalizing function F(X), the following Equation (4a) or (4b) can be used, for example.

### Equation 2

### Math.2

$${a}_{j} = F \left(\left‖{u}_{j}\right‖\right) = s o f t m a x \left(\left‖{u}_{j}\right‖\right) = \frac{e x p \left(β \left‖{u}_{j}\right‖\right)}{{\sum }_{k} e x p \left(β \left‖{u}_{k}\right‖\right)}$$

$${a}_{j} = F \left(\left‖{u}_{j}\right‖\right) = \frac{\left‖{u}_{j}\right‖}{{Σ}_{k} \left‖{u}_{k}\right‖}$$

Here,
k represents an ordinal number for all nodes in the upper layer L+1; and
β represents an adjustment parameter that is a given positive coefficient, and is for example β = 1.

With the Equation (4a) described above, the norm |uⱼ| of the sum vector uⱼ concerning all the nodes in the upper layer L+1 is normalized using a softmax function to obtain the activation value aⱼ. On the other hand, with the Equation (4b) described above, the norm |uⱼ| of the sum vector uⱼ is divided by the sum of norms |uⱼ|concerning all the nodes in the upper layer L+1 to obtain the activation value aⱼ. Note that, as for the normalizing function F(X), it may be possible to use functions other than the Equation (4a) or (4b).

The ordinal number i in the Equation (3) described above is assigned to nodes in the lower layer L used to determine the output vector M^{L+1}ⱼ of the j-th node in the upper layer L+1 for the purpose of convenience, and takes a value that falls in a range of 1 to n. In addition, the integer n is the number of nodes in the lower layer L used to determine the output vector M^{L+1}ⱼ at the j-th node in the upper layer L+1. Thus, the integer n is given in the following Equation.

$$n = N k \text{} \text{} \times N c$$

Here, Nk is the number of elements of a kernel, and Nc is the number of channels in the PrimeVN layer 221 that is a lower layer. In the example in FIG. 3, since Nk = 3 and Nc = 26, n = 78 establishes.

One kernel used to obtain the output vector of the ConvVN1 layer 231 includes 1 × 3 × 26 = 78 pieces of elements with the planar size being the kernel size 1 × 3 and the number of channels of 26 in the lower layer being the depth, and each of these elements constitutes a predicted matrix W^{L}ᵢⱼ. In addition, 20 sets of the kernels are necessary to generate an output vector with 20 pieces of channels of the ConvVN1 layer 231. Thus, the number of predicted matrixes W^{L}ᵢⱼ of the kernel used to obtain the output vector of the ConvVN1 layer 231 is 78 × 20 = 1560. These predicted matrixes W^{L}ᵢⱼ are updated through training of the machine learning model 201.

As can be understood from the Equations (2) to (5) described above, the output vector M^{L+1}ⱼ of each of the nodes in the upper layer L+1 can be obtained through the following computation.
(a) Multiplying the output vector M^{L}ᵢ of each of the nodes in the lower layer L by the predicted matrix W^{L}ᵢⱼ to obtain the predicted vector vᵢⱼ.
(b) Obtaining a sum of the predicted vectors vᵢⱼ obtained from individual nodes in the lower layer L, that is, the sum vector uⱼ that is a linear combination.
(c) Normalizing the norm |uⱼ|of the sum vector uⱼ to obtain the activation value aⱼ that is a normalizing constant.
(d) Dividing the sum vector uⱼ by the norm |uⱼ|, and further multiplying the activation value aⱼ.

Note that the activation value aⱼ is a normalizing constant obtained by normalizing the norm |uⱼ|concerning all the nodes in the upper layer L+1. Thus, it can be considered that the activation value aⱼ is an indicator indicating the relative output intensity of each of the nodes of all the nodes within the upper layer L+1. The norms used in the Equation (4), the Equation (4a), the Equation (4b), and the Equation (5) are L2 norms indicating the vector length in a typical example. At this time, the activation value aⱼ corresponds to the vector length of the output vector M^{L+1}ⱼ. The activation value aⱼ is used only in the Equation (4) and the Equation (5) described above, and hence, does not need to be outputted from the node. However, the upper layer L+1 may be configured so as to output the activation value aⱼ to the outside.

The configuration of the vector neural network is almost the same as the configuration of the capsule network, and the vector neuron of the vector neural network corresponds to a capsule of the capsule network. However, computation through the Equations (2) to (5) described above and used in the vector neural network differs from computation used in the capsule network. The largest difference between them lies in that, in the capsule network, a weight is multiplied to the predicted vector vij on the the right-hand side of the Equation (3) described above, and this weight is searched by repeating dynamic routing a plurality of times. On the other hand, the vector neural network according to the present embodiment has an advantage in that the output vector M^{L+1}ⱼ can be obtained by sequentially calculating the Equations (2) to (5) described above one time, which eliminates the need of repeating dynamic routing and results in an increase in the computation. In addition, the vector neural network according to the present embodiment has an advantage in that the amount of memory required to perform computation is less than that by the capsule network, and is only approximately ½ to ⅓ of that by the capsule network on the basis of experiments made by the inventor of the present disclosure.

From the viewpoint of using nodes where vectors are input and outputted, the vector neural network and the capsule network are the same. Thus, the advantages of using the vector neuron are common to those of the capsule network. In addition, it is the same as the convolutional neural network from the viewpoint where the plurality of layers 211 to 251 represent features having larger regions toward the upper layers, and represent features having smaller regions toward the lower layers. Here, the “feature” means a characteristic portion included in input data into the neural network. The vector neural network or the capsule network is superior to a typical convolutional neural network in that an output vector of a certain node contains spatial information indicating space-related information of a feature that this node represents. That is, the vector length of an output vector of a certain node represents a probability that a feature that this node represents exists, and the vector direction represents a direction of the feature or spatial information such as a scale. Thus, vector directions of output vectors of two nodes that belong to the same layer represent a positional relationship of each feature. Alternatively, it can be said that the vector directions of output vectors of these two nodes represent a variation of features. For example, in a case of a node that corresponds to a feature of “eye”, the direction of the output vector can represent a variation such as how narrow the shape of eye is or the way in which the shape of the eye slants. In a typical convolutional neural network, it is said that the spatial information about a feature is dropped off through pooling processing. Thus, the vector neural network or the capsule network has an advantage in that they are superior in terms of a performance of identifying input data, as compared with a typical convolutional neural network.

The advantage of the vector neural network can be considered in the following manner. That is, the vector neural network has an advantage in that the output vector of a node represents a feature of input data as a coordinate within a continuous space. Thus, the output vector can be evaluated such that features are similar when the vector directions are close to each other. Furthermore, there is another advantage or the like in that, when training data does not cover a feature included in input data, the feature can be identified through interpolation. On the other hand, a typical convolutional neural network has a drawback in that disordered compression is performed through pooling processing, and thus, a feature of input data cannot be expressed as a coordinate within a continuous space.

The output from each of the nodes in the ConvVN2 layer 241 and the ClassVN layer 251 is determined in a similar manner using the Equations (2) to (5) described above, and hence, detailed explanation thereof will not be repeated. The resolution of the ClassVN layer 251 that is the uppermost layer is 1 × 1, and the number of channels is n1.

The output from the ClassVN layer 251 is converted into a plurality of determination values Class1-1to Class1-10 for known classes. These determination values are usually values normalized through a softmax function. Specifically, for example, computation is performed such that, on the basis of an output vector of each of the nodes of the ClassVN layer 251, the vector length of this output vector is calculated, and then, the vector length of each of the nodes is normalized using the softmax function. This makes it possible to obtain determination values for individual classes. As described above, the activation value aⱼ obtained through the Equation (4) described above is a value that corresponds to the vector length of the output vector M^{L+1}ⱼ, and has been normalized. Thus, it may be possible to output the activation value aⱼ for each of the nodes in the ClassVN layer 251 and directly use it as a determination value for each class.

In the embodiment described above, a vector neural network for obtaining an output vector through computation of the Equations (2) to (5) described above is used as the machine learning model 201, 202. However, instead, it may be possible to use a capsule network disclosed in U.S. 5210798 or WO 2019/083553. Furthermore, it may be possible to use a neural network using only a scalar neuron.

### Other Aspects

The present disclosure is not limited to the embodiment described above, and may be implemented in various aspects without departing from the spirits of the disclosure. For example, the present disclosure can be achieved with the following aspects. Technical features in the embodiment described above that correspond to technical features in each of the aspects described below can be replaced or combined on an as-necessary basis, in order to solve part of or all of the problems of the present disclosure, or achieve part of or all of the effects of the present disclosure. Furthermore, when the technical features are not described herein as essential technical features, such technical features may be deleted on an as-necessary basis.

<1> A first aspect according to the present disclosure provides a method of performing classification processing on classification target data using a machine learning model including a vector neural network including a plurality of vector neuron layers. This method includes: (a) preparing N machine learning models, each of the N machine learning models being configured to classify input data into any one of a plurality of classes, each of the N machine learning models being also configured to include at least one class differing from other machine learning models of the N machine learning models, where N is an integer equal to or more than 2; (b) when a plurality of pieces of training data are input into the N machine learning models, preparing a known feature vector group obtained from output of at least one specific layer of the plurality of vector neuron layers; and (c) computing, using a selected machine learning model selected from the N machine learning models, a similarity, for each class, between the known feature vector group and a feature vector obtained from output of the specific layer when the classification target data is input into the selected machine learning model, and determining a class for the classification target data using the similarity.

With this method, the classification processing is performed by using the N machine learning models. This makes it possible to rapidly perform the process, as compared with a case where classification is performed into a large number of classes using one machine learning model. In addition, a class for the classification target data is determined using a similarity of feature vectors, which makes it possible to perform the classification processing in a highly accurate manner.

<2> In the method described above, the step (c) may include: (c1) selecting one machine learning model from among the N machine learning models as the selected machine learning model; (c2) computing the similarity using the selected machine learning model to determine a class for the classification target data using the similarity; (c3) when the classification target data is not determined to belong to a known class in the step (c2), returning to the step (c1) and selecting a next machine learning model to perform the step (c2); and (c4) when a result of the classification processing using all the N machine learning models indicates that the classification target data does not belong to any known class, determining that the classification target data belongs to an unknown class.

With this method, machine learning models are selected one by one to perform the classification process. Thus, it is more likely that a class for the classification target data can be determined faster.

<3> The method described above may be configured such that; an upper limit value is set to the number of classes into which classification is performed using any one machine learning model from among the N machine learning models; of the N machine learning models, (N - 1) machine learning models include a number of classes equal to the upper limit value, the other one machine learning model includes a number of classes equal to or less than the upper limit value; and when the classification processing is performed on the classification target data using the N machine learning models and the classification target data is determined to belong to an unknown class, the step (c) includes: (1) when the other one machine learning model includes a number of classes less than the upper limit value, performing training of the other one machine learning model using training data including the classification target data to add a new class for the classification target data, and (2) when the other one machine learning model includes a number of classes equal to the upper limit value, adding a new machine learning model including a class that corresponds to the classification target data.

With this method, when classification cannot be successfully performed on the classification target data using the N machine learning models, a class is added to the existing machine learning models or a new machine learning model is added, which makes it possible to perform classification for a class that corresponds to this classification target data.

<4> The method described above may be configured such that the step (2) includes: performing training of the new machine learning model using training data including the classification target data used in the step (c), and the training data further includes existing training data used to perform training concerning at least one class included in the N machine learning models.

With this method, in addition to the training data used to perform training of a new class, the existing training data used to perform training of the existing class is used to perform training of a new machine learning model. This makes it possible to perform classification using the new machine learning model in a more accurate manner.

<5> The method described above may be configured such that the specific layer has a configuration in which a vector neuron disposed at a plane defined by two axes of a first axis and a second axis is disposed across a plurality of channels along a third axis extending in a direction differing from the two axes, and the feature vector is any one of: (i) a first type feature spectrum in which a plurality of element values of an output vector of vector neuron at one planar position of the specific layer are arrayed across the plurality of channels along the third axis; (ii) a second type feature spectrum obtained by multiplying each of the element values of the first type feature spectrum by an activation value corresponding to a vector length of the output vector; and (iii) a third type feature spectrum in which the activation value at a planar position of the specific layer is arrayed across the plurality of channels along the third axis.

With this method, it is possible to easily obtain a feature vector.

<6> The method described above may further include: receiving an instruction indicating that one known class of the plurality of classes is set to a delete target class; and in a machine learning model including the delete target class, changing an output name of the delete target class into a name indicating that the delete target class is deleted or unknown, or deleting one channel from an output layer of the machine learning model including the delete target class to restructure the machine learning model, and performing training of the restructured machine learning model.

With this method, when a known class is not necessary, this known class can be deleted, which makes it possible to increase the accuracy of the classification processing using a machine learning model.

<7> A second aspect according to the present disclosure provides an information processing device configured to perform classification processing on classification target data using a machine learning model including a vector neural network including a plurality of vector neuron layers. This information processing device includes a memory configured to store the machine learning model, and one or more processors configured to execute computation using the machine learning model. The one or more processors perform: (a) processing of preparing N machine learning models, each of the N machine learning models being configured to classify input data into any one of a plurality of classes, each of the N machine learning models being also configured to include at least one class differing from other machine learning models of the N machine learning models, where N is an integer equal to or more than 2; (b) processing of, when a plurality of pieces of training data are input into the N machine learning models, preparing a known feature vector group obtained from output of at least one specific layer of the plurality of vector neuron layers; and (c) processing of computing, using a selected machine learning model selected from the N machine learning models, a similarity, for each class, between the known feature vector group and a feature vector obtained from output of the specific layer when the classification target data is input into the selected machine learning model, and determining a class for the classification target data using the similarity.

With this information processing device, the classification processing is performed using the N machine learning models. This makes it possible to perform the process at high speed, as compared with a case of performing processing of classification into a large number of classes using one machine learning model. In addition, a class for the classification target data is determined using a similarity of feature vectors, which makes it possible to perform the classification processing in a highly accurate manner.

<8> A third aspect according to the present disclosure provides a non-transitory computer-readable storage medium storing a computer program, the computer program being configured to cause one or more processors to perform classification processing on classification target data using a machine learning model including a vector neural network including a plurality of vector neuron layers. The computer program is configured to cause the one or more processors to perform: (a) processing of preparing N machine learning models, each of the N machine learning models being configured to classify input data into any one of a plurality of classes, each of the N machine learning models being also configured to include at least one class differing from other machine learning models of the N machine learning models, where N is an integer equal to or more than 2; (b) processing of, when a plurality of pieces of training data are input into the N machine learning models, preparing a known feature vector group obtained from output of at least one specific layer of the plurality of vector neuron layers; and (c) processing of computing, using a selected machine learning model selected from the N machine learning models, a similarity, for each class, between the known feature vector group and a feature vector obtained from output of the specific layer when the classification target data is input into the selected machine learning model, and determining a class for the classification target data using the similarity.

With this computer program, the classification processing is performed using the N machine learning models. This makes it possible to perform the process at high speed, as compared with a case of performing processing of classification into a large number of classes using one machine learning model. In addition, a class for the classification target data is determined using a similarity of feature vectors, which makes it possible to perform the classification processing in a highly accurate manner.

The present disclosure can be achieved in various types of aspects other than those described above. For example, it is possible to achieve the present disclosure in aspects such as a computer program used to achieve functions of a classification device or a non-transitory storage medium on which this computer program is recorded.

What is claimed is:

1. A method of performing classification processing on classification target data using a machine learning model including a vector neural network including a plurality of vector neuron layers, the method comprising:
(a) preparing N machine learning models, each of the N machine learning models being configured to classify input data into any one of a plurality of classes, each of the N machine learning models being also configured to include at least one class differing from other machine learning models of the N machine learning models, where N is an integer equal to or more than 2;
(b) when a plurality of pieces of training data are input into the N machine learning models, preparing a known feature vector group obtained from output of at least one specific layer of the plurality of vector neuron layers; and
(c) computing, using a selected machine learning model selected from the N machine learning models, a similarity, for each class, between the known feature vector group and a feature vector obtained from output of the specific layer when the classification target data is input into the selected machine learning model, and determining a class for the classification target data using the similarity.

2. The method according to claim 1, wherein
the step (c) includes:
(c1) selecting one machine learning model from among the N machine learning models as the selected machine learning model;
(c2) computing the similarity using the selected machine learning model to determine a class for the classification target data using the similarity;
(c3) when the classification target data is not determined to belong to a known class in the step (c2), returning to the step (c1) and selecting a next machine learning model to perform the step (c2); and
(c4) when a result of the classification processing using all the N machine learning models indicates that the classification target data does not belong to any known class, determining that the classification target data belongs to an unknown class.

3. The method according to claim 1, wherein
an upper limit value is set to the number of classes into which classification is performed using any one machine learning model from among the N machine learning models,
of the N machine learning models, (N - 1) machine learning models include a number of classes equal to the upper limit value,
the other one machine learning model includes a number of classes equal to or less than the upper limit value,
when the classification processing is performed on the classification target data using the N machine learning models and the classification target data is determined to belong to an unknown class, the step (c) includes:
(1) when the other one machine learning model includes a number of classes less than the upper limit value, performing training of the other one machine learning model using training data including the classification target data, to add a new class for the classification target data; and
(2) when the other one machine learning model includes a number of classes equal to the upper limit value, adding a new machine learning model including a class that corresponds to the classification target data.

4. The method according to claim 3, wherein
the step (2) includes
performing training of the new machine learning model using training data including the classification target data used in the step (c), and
the training data further includes existing training data used to perform training concerning at least one class included in the N machine learning models.

5. The method according to claim 1, wherein
the specific layer is configured such that a vector neuron disposed at a plane defined by two axes of a first axis and a second axis is disposed across a plurality of channels along a third axis extending in a direction differing from the two axes, and
the feature vector is any one of:
(i) a first type feature spectrum in which a plurality of element values of an output vector of vector neuron at one planar position of the specific layer are arrayed across the plurality of channels along the third axis;
(ii) a second type feature spectrum obtained by multiplying each of the element values of the first type feature spectrum by an activation value corresponding to a vector length of the output vector; and
(iii) a third type feature spectrum in which the activation value at a planar position of the specific layer is arrayed across the plurality of channels along the third axis.

6. The method according to claim 1 further comprising:
receiving an instruction indicating that one known class of the plurality of classes is set to a delete target class; and
in a machine learning model including the delete target class, changing an output name of the delete target class into a name indicating that the delete target class is deleted or unknown, or deleting one channel from an output layer of the machine learning model including the delete target class to restructure the machine learning model, and performing training of the restructured machine learning model.

7. An information processing device configured to perform classification processing on classification target data using a machine learning model including a vector neural network including a plurality of vector neuron layers, the information processing device comprising:
a memory configured to store the machine learning model; and
one or more processors configured to execute computation using the machine learning model, wherein
the one or more processors perform:
(a) processing of preparing N machine learning models, each of the N machine learning models being configured to classify input data into any one of a plurality of classes, each of the N machine learning models being also configured to include at least one class differing from other machine learning models of the N machine learning models, where N is an integer equal to or more than 2;
(b) processing of, when a plurality of pieces of training data are input into the N machine learning models, preparing a known feature vector group obtained from output of at least one specific layer of the plurality of vector neuron layers; and
(c) processing of computing, using a selected machine learning model selected from the N machine learning models a similarity, for each class, between the known feature vector group and a feature vector obtained from output of the specific layer when the classification target data is input into the selected machine learning model, and determining a class for the classification target data using the similarity.

8. A non-transitory computer-readable storage medium storing a computer program, the computer program being configured to cause one or more processors to perform classification processing on classification target data using a machine learning model including a vector neural network including a plurality of vector neuron layers, the computer program being configured to cause the one or more processors to perform:
(a) processing of preparing N machine learning models, each of the N machine learning models being configured to classify input data into any one of a plurality of classes, each of the N machine learning models being also configured to include at least one class differing from other machine learning models of the N machine learning models, where N is an integer equal to or more than 2;
(b) processing of, when a plurality of pieces of training data are input into the N machine learning models, preparing a known feature vector group obtained from output of at least one specific layer of the plurality of vector neuron layers; and
(c) processing of computing, using a selected machine learning model selected from the N machine learning models, a similarity, for each class, between the known feature vector group and a feature vector obtained from output of the specific layer when the classification target data is input into the selected machine learning model, and determining a class for the classification target data using the similarity.
